(19) United States
(12) Patent Application Publication
(10) Pub. No.: US 2007/0002209 A1
(43) Pub. Date: Jan. 4, 2007

(54) Liquid crystal display with frame to shield electromagnetic interference

(75) Inventors: Ming-Bo Tai, Shenzhen (CN); Tian-Yi Wu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/479,526

(22) Filed: Jun. 30, 2006

(30) Foreign Application Priority Data
Jul. 1, 2005 (TW) 94211125

(51) Int. Cl. G02F 1/1333

(52) U.S. Cl. 349/58

(57) ABSTRACT

An exemplary liquid crystal display (200) includes a liquid crystal panel (210) having a first substrate (212), a second substrate (214), a liquid crystal layer (213) sandwiched between the first and second substrates, and a transparent conductive layer (215) disposed at an outer surface of the second substrate; a backlight module (230) disposed adjacent to an outer surface of the liquid crystal display panel; and a frame (250). The frame includes at least one connecting portion (252) electrically connecting to a peripheral edge portion of the transparent conductive layer. The frame and the transparent conductive layer cooperatively forming a substantially closed space containing the backlight module, so as to shield the liquid crystal panel form any electromagnetic interference may be generated by the backlight module including the lamps.

### FIELD OF THE INVENTION

The present invention relates to display devices, and more particularly to a liquid crystal display having a frame to reduce electromagnetic interference.

### BACKGROUND

Nowadays, liquid crystal displays are widely used in products such as notebook computers and portable TVs. Each of these products generally includes a liquid crystal panel, and a backlight system to provide uniform collimated light to the liquid crystal panel. The backlight system mainly includes a light source and a light guide plate. The light guide plate is commonly made of a transparent acrylic resin, and is used for guiding light beams emitted by the light source to uniformly illuminate the liquid crystal panel.

A cold cathode fluorescent lamp (CCFL) is a kind of light source that is frequently used in backlight modules. The CCFL typically has a high driving voltage of approximately 1000 volts, and a high operating frequency of approximately 1000 hertz. Therefore the CCFL is liable to generate a large amount of unwanted electromagnetic waves, which may cause electromagnetic interference (EMI). In particular, the EMI may cause a display screen of the liquid crystal panel to flicker.

Accordingly, what is needed is a liquid crystal display that can overcome the above-described deficiencies.

### SUMMARY

An exemplary liquid crystal display includes a liquid crystal panel having a first glass substrate, a second glass substrate, a liquid crystal layer sandwiched between the first and second substrates, and a transparent conductive layer disposed at an outer surface of the second substrate; a backlight module disposed adjacent to an outer surface of the liquid crystal panel; and a frame. The frame includes at least one connecting portions electrically connecting to a peripheral edge portion of the transparent conductive layer.

The frame and the transparent conductive layer cooperatively forming a substantially closed space containing the backlight module, so as to shield the liquid crystal panel form any electromagnetic interference may be generated by the backlight module including the lamps.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is a side cross-sectional view of a liquid crystal display according to a first exemplary embodiment of the present invention.

FIG. 2 is an isometric view of a frame of the liquid crystal display of FIG. 1.

FIG. 3 is an isometric view of a frame used in a liquid crystal display according to a second exemplary embodiment of the present invention.

FIG. 4 is an isometric view of a frame used in a liquid crystal display according to a third exemplary embodiment of the present invention.

### DETAILED DESCRIPTION OF PREFERRED EMBODIMENTS

Reference will now be made to the drawings to describe preferred and exemplary embodiments of the present invention in detail.

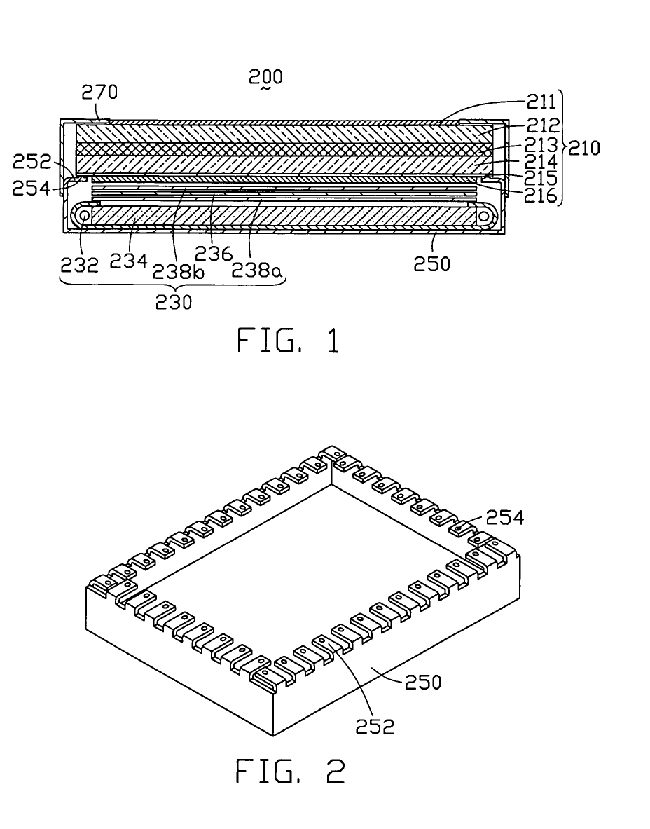

Referring to FIG. 1, this is a schematic, side cross-sectional view of a liquid crystal display according to a first exemplary embodiment of the present invention. The liquid crystal display 200 includes a liquid crystal panel 210, a backlight module 230, a lower frame 250, and an upper frame 270.

The liquid crystal panel 210 includes an upper polarizer 211, an upper glass substrate 212, a liquid crystal layer 213, a lower glass substrate 214, a transparent conductive layer 215, and a lower polarizer 216, disposed in that order from top to bottom. The transparent conductive layer 215 may be an indium-tin-oxide (ITO) layer or an indium-zinc-oxide (IZO) layer, which has a thickness of less than 0.2 millimeters. A peripheral edge portion (not labeled) of the transparent conductive layer 215 is not covered by the lower polarizer 216.

The backlight module 230 includes a light guide plate 234, two lamps 232 respectively disposed adjacent to two opposite side surfaces (not labeled) of the light guide plate 234, and a set of optical films disposed adjacent to a top surface (not labeled) of the light guide plate 234. In the illustrated embodiment, the set of optical films includes a lower diffusion sheet 238a, a prism sheet 236, and an upper diffusion sheet 238b, disposed in that order from bottom to top. The lamps 232 may be cold cathode fluorescent lamps.

The upper and lower frame 270 and 250 can be made of aluminum alloy, iron alloy, or a like material. Also referring to FIG. 2, the lower frame 250 includes a plurality of individual connecting portions 252 at a top thereof. Each of the connecting portions 252 is a single body that extends from a top end of a respective one of the four side walls, and that is inwardly folded. That is, a major part of each of the connecting portions 252 is horizontally oriented. Each of the connecting portions 252 includes a bump 254. The bump 254 is located at an upper surface of the connecting portion 252, near a free end thereof.

In assembly, the liquid crystal panel 210 is accommodated in the upper frame 270, and the backlight module 230 is accommodated in the lower frame 250. The upper frame 270 and the lower frame 250 are engaged with each other, whereby the backlight module 230 is disposed under the liquid crystal panel 210 for providing light beams to illuminate the liquid crystal panel 210. The connecting portions 252 are electrically connected with the peripheral edge portion of the transparent conductive layer 215 via the bumps 254. Thereby, good electrical connections are established between the connecting portions 252 and the transparent conductive layer 215. Further, the lower frame 250 and the transparent conductive layer 215 cooperatively form a substantially closed space containing the backlight module 230, so as to shield the liquid crystal panel 210 from any electromagnetic interference that may be generated by the backlight module 230 including the lamps 232.

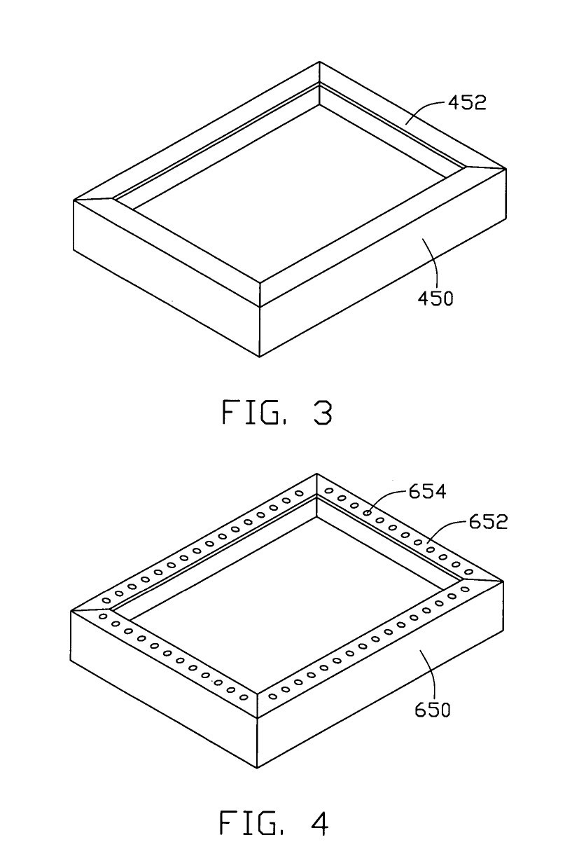

Referring to FIG. 3, this is a schematic, isometric view of a frame used in a liquid crystal display according to a second exemplary embodiment of the present invention. In other respects, the liquid crystal display is similar to the above-described liquid crystal display 200 of the first exemplary embodiment. The frame 450 includes a connecting portion 452, which is integrally formed with a main body of the frame 450. The connecting portion 452 includes four sections that extend from top ends of four side walls of the frame 450 respectively, and that are inwardly folded. That is, a major part of each of the sections is horizontally oriented. When the frame 450 is employed in the liquid crystal display, the four sections of the connecting portions 452 electrically connect with the peripheral edge portion of the transparent conductive layer 215. Thereby, the frame 450 and the transparent conductive layer 215 cooperatively form a substantially closed space containing the backlight module 230, so as to shield the liquid crystal panel 210 from any electromagnetic interference that may be generated by the backlight module 230 including the lamps 232.

Referring to FIG. 4, this is a schematic, isometric view of a frame used in a liquid crystal display according to a third exemplary embodiment of the present invention. In other respects, the liquid crystal display is similar to the above-described liquid crystal display 200 of the first exemplary embodiment. The frame 650 is similar to the above-described frame 450 of the second exemplary embodiment. The frame 650 includes a connecting portion 652. The connecting portion 652 is integrally formed with a main body of the frame 650. In addition, the connecting portion 652 includes a plurality of aligned bumps 654 located at an upper surface thereof. When the frame 650 is employed in the liquid crystal display, the bumps 654 establish good electrical connections between the connecting portion 652 and the transparent conductive layer 215. Further, the frame 650 and the transparent conductive layer 215 cooperatively form a substantially closed space containing the backlight module 230 therein, so as to shield the liquid crystal panel 210 from any electromagnetic interference that may be generated by the backlight module 230 including the lamps 232.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display, comprising:
a liquid crystal panel comprising a first substrate, a second substrate, a liquid crystal layer sandwiched between the first and second substrates, and a transparent conductive layer disposed at an outer surface of the second substrate;
a backlight module disposed adjacent to an outer surface of the liquid crystal panel; and
a first frame comprising at least one connecting portion electrically connecting to a peripheral edge portion of the transparent conductive layer, the first frame and the transparent conductive layer cooperatively forming a substantially closed space containing the backlight module.

2. The liquid crystal display as claimed in claim 1, wherein the transparent conductive layer has a thickness of less than 0.2 millimeters.

3. The liquid crystal display as claimed in claim 2, wherein the transparent conductive layer is an indium-tin-oxide layer.

4. The liquid crystal display as claimed in claim 2, wherein the transparent conductive layer is an indium-zinc-oxide layer.

5. The liquid crystal display as claimed in claim 1, wherein the at least one connecting portion extends from a top end of a main body of the first frame, is inwardly folded.

6. The liquid crystal display as claimed in claim 5, wherein a major part of the at least one connecting portion is horizontally oriented.

7. The liquid crystal display as claimed in claim 6, wherein the least one connecting portion comprises a bump located at an upper surface thereof, and the bump abuts the peripheral edge portion of the transparent conductive layer.

8. The liquid crystal display as claimed in claim 1, wherein the first frame comprises four side walls.

9. The liquid crystal display as claimed in claim 8, wherein the at least one connecting portion comprises four sections that extend from top ends of the four side walls of the first frame respectively, and that are inwardly folded.

10. The liquid crystal display as claimed in claim 9, wherein a major part of each of the sections is horizontally oriented.

11. The liquid crystal display as claimed in claim 10, wherein each of the sections comprises a plurality of bumps located at an upper surface thereof.

12. The liquid crystal display as claimed in claim 1, wherein the first frame is made of one of aluminum alloy and iron alloy.

13. The liquid crystal display as claimed in claim 1, further comprising a second frame accommodating the liquid crystal panel, wherein the first frame and the second frame are engaged with each other.

14. A liquid crystal display, comprising:
a liquid crystal panel comprising a first substrate, a second substrate, a liquid crystal layer sandwiched between the first and second substrates, and a transparent conductive layer disposed at an outer surface of the second substrate;
a backlight module disposed adjacent to an outer surface of the liquid crystal panel; and
a first frame comprising at least one connecting portion not only electrically connecting to a peripheral portion of the transparent conductive layer, but also mechanically providing a supporting force perpendicular to the outer surface.

15. The liquid crystal display as claimed in claim 14, further including a second frame located above the first frame and receiving a liquid crystal panel therein.

16. The liquid crystal display as claimed in claim 15, where the second frame surrounds the first frame around a joint region therebetween.
